(19) United States
(12) Patent Application Publication
(10) Pub. No.: US 2010/0131382 A1
(43) Pub. Date: May 27, 2010

(54) System and Method for Auctioning Audio Submission Rights

(76) Inventor: Jeff Fitzsimmons, Milwaukee, WI (US)

Correspondence Address: BOYLE FREDRICKSON S.C., 840 North Plankinton Avenue, MILWAUKEE, WI, 53203, US

(21) Appl. No.: 12/578,945

(22) Filed: Oct. 14, 2009

Related U.S. Application Data
(60) Provisional application No. 61/105,616, filed on Oct. 15, 2008.

(51) Int. Cl. G06F 3/048; G06Q 30/00; H04M 11/00

(52) U.S. Cl. 705/26; 715/780; 379/88.13

(57) ABSTRACT

A computer-implemented method for auctioning rights and receiving recorded bid proposals using a telephony system. The method includes receiving one or more submitted bids for access to a bid proposal recording system, determining a winning bid from the one or more submitted bids, initiating a telephone call to a selected telephone number associated with the winning bid, recording at least a portion of the telephone call to generate a recorded bid proposal, and posting the recorded bid proposal on a computer implemented graphical interface to allow one or more proposal reviewer to access the recorded bid proposal.

### CROSS-REFERENCE TO RELATED APPLICATIONS

This application claims priority to U.S. Provisional Application No. 61/105,616, filed Oct. 15, 2008, the entirety of which is herein incorporated by reference.

### FIELD

The present invention relates to systems and methods for implementing an auction for access to a telephonic message recording system. Specifically, the present invention relates to a system and method for auctioning access to a telephonic messaging system that allows the winner to submit an unsolicited bid proposal for review by a bid reviewer.

### BACKGROUND

Corporations and venture capitalist are frequently inundated with unsolicited proposals or pitches of ideas. Unfortunately, a significant number of these ideas may not provide any value to the person hearing the proposal, causing the person to spend time and resources without maximizing their benefit. However, while the majority of proposals may be of low value, some proposals have the potential to provide a significant value. Accordingly, while it may be desirable to receive unsolicited pitches, it is equally desirable to have a mechanism in place to minimize the reviewing costs and to increase the likelihood that a proposal will be of value.

Conventional proposal review often requires scheduling a time when both the proposer and the reviewer are available at a location usually associated with the questioner. In person review requires that the proposer travel to the location of the questioner. A telephone interview solves the problem of travelling to a single location, but still requires that the proposer and reviewer coordinate their schedules.

Further, conventional proposal review for unsolicited bids often requires minimal effort and cost outlay for the proposer, but significant costs in time and resources for the reviewer having to review significant numbers of proposal, the majority of which are of little value. A proposer that sees potential value in their proposal may be will to invest more effort and cost outlay for the potential to capture the value of the proposal.

What is needed is a bid proposal system and method for allowing a user to submit an audio bid proposal. What is further needed is such a system and method configured to require the proposer to successfully complete a bidding process for an opportunity to submit the audio bid proposal.

### SUMMARY

A computer-implemented method for auctioning rights and receiving recorded bid proposals using a telephony system is described. The method includes receiving one or more submitted bids for access to a bid proposal recording system, determining a winning bid from the one or more submitted bids, initiating a telephone call to a selected telephone number associated with the winning bid, recording at least a portion of the telephone call to generate a recorded bid proposal, and posting the recorded bid proposal on a computer implemented graphical interface to allow one or more proposal reviewer to access the recorded bid proposal.

According to another exemplary embodiment, a computer-implemented system for generating audio content using a telephony system is shown. The system includes a bidding proposal right auctioning system configured to select a winning bid from one or more submitted bids for right to submit a bid proposal, a telephony system configured to initiate a telephone call based on the selected winning bid, and an unsolicited bid proposal audio files management system. The bid proposal audio files management system is configured to perform a plurality of steps to receive audio bid proposals using the telephony system, including receiving a telephone call initiation request through a computer implemented graphical interface, initiating a telephone call to a selected telephone number, recording at least a portion of the telephone call to generate audio bid proposals, and posting the bid proposal on the computer implemented graphical interface to allow one or more reviewers to access the bid proposals.

Other features and advantages of the invention will become apparent to those skilled in the art from the following detailed description and accompanying drawings. It should be understood, however, that the detailed description and specific examples, while indicating the preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout, and in which:

FIG. 1 is a system for unsolicited bid proposal auctioning and recording including auctioning, receiving, storing and allowing retrieval of unsolicited bid proposals using a telephony system, according to an exemplary embodiment;

FIG. 2 is a flowchart illustrating a method for implementing an auction for the right to submit an unsolicited bid proposal implemented by the proposal auctioning system of FIG. 1, according to an exemplary embodiment

FIG. 3 is a flowchart illustrating a method for allowing a user to submit an unsolicited bid proposal using a computing system and a telephone device following completion of a successful auction, according to an exemplary embodiment; and

FIG. 4 is a computer implemented graphical interface for reviewing, sharing, and providing comments on unsolicited bid proposal files, according to an exemplary embodiment.

Before explaining embodiments of the invention in detail, it is to be understood that the invention is not limited in its application to the details of construction and the arrangement of the components set forth in the following description and illustrated in the drawings. The invention is capable of other embodiments or being practiced or carried out in various ways. Also, it is to be understood that the phraseology and terminology employed herein is for the purpose of description and should not be regarded as limiting.

### DETAILED DESCRIPTION

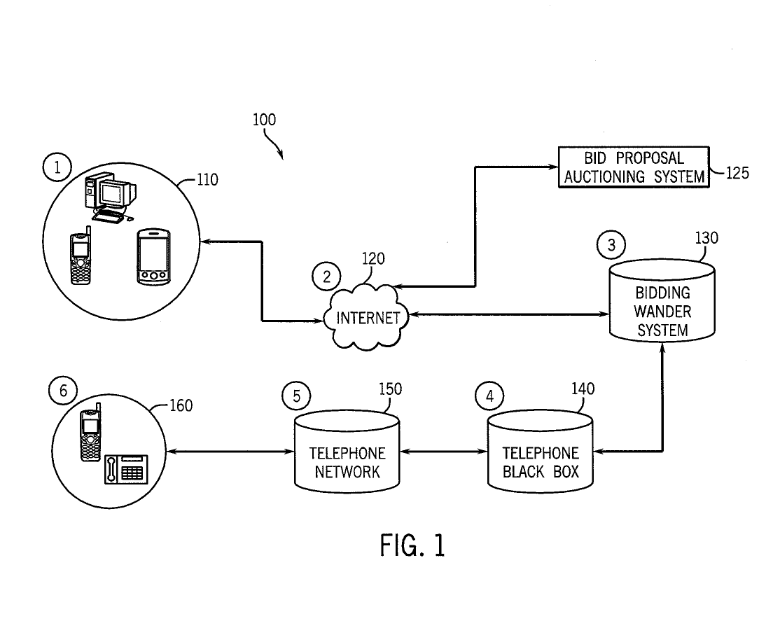

Referring now to FIG. 1, an unsolicited bid proposal auctioning and receiving system 100 for implementing an auction and receiving, storing, and allowing retrieval of unsolicited bid proposal audio files using a telephony system is shown, according to an exemplary embodiment. System 100 is configured to include a user computing system 110 connected to a bid proposal auction system 125 and an unsolicited bid proposal audio files management system 130 through a communication network 120, such as the Internet. Proposal audio files management system 130 is further connected to a telephone network 150 through a telephony system 140 configured to allow system 130 to initiate audio communication with a user through a user telephone device 160. Although system 100 is shown and described as including particular systems and devices in a particular configuration, it should be understood that system 100 may alternatively include more, less, and/or a different configuration of devices and systems configured to implement the functionality described herein.

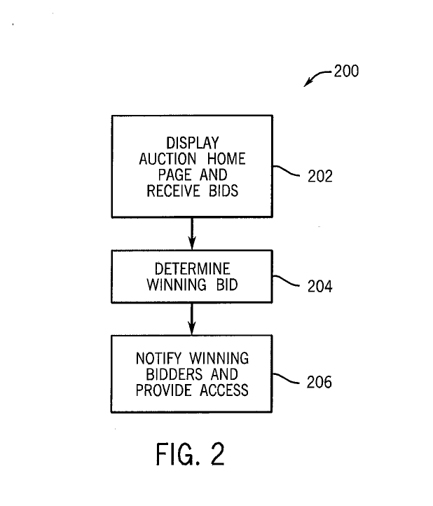

Computer system 110 is representative of the wide range of large and small computer systems that are used in computer networks of all types. For example, computer system 110 may be a desktop computing system, a laptop communication system, a handheld computing device, a smart phone, or any other web-enabled computing device configurable to allow a user to access system 130 using communication network 120 and initiate an audio content generation method, described below in further detail with reference to FIGS. 2-4. Although only a single computing system 110 is shown in FIG. 1, it should be understood that the method and system described herein may be used to connect system 130 to a larger number of different systems 110 and device 160.

Communication network 120 is intended to be representative of the complete spectrum of computer network types including Internet and internet-like networks. Communication network 120 may be utilized to allow communication between system 130 and any number of computer systems, of which computer system 110 is representative.

Proposal auctioning system 125 may be implemented use any of a variety of computing system configured to implement an online auction where bidders are bidding for access to the unsolicited bid proposal audio files management system 130. The method for implementing the auction is described in further detail below with reference to FIG. 2.

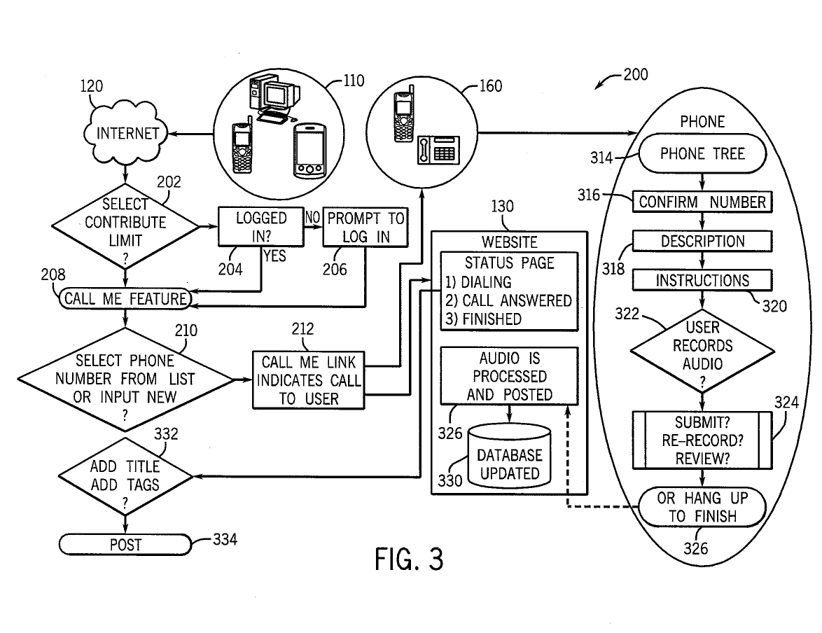

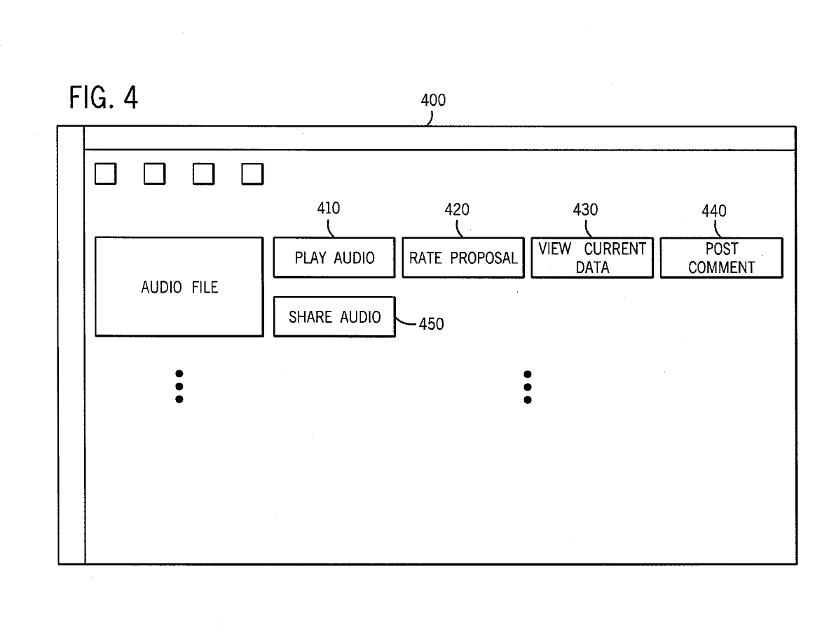

Unsolicited bid proposal audio files management system 130 may be implemented using any of a variety of computing systems configured to implement a web server function and a telephony system service. Unsolicited bid proposal audio files management system 130 is configured to implement functionality allowing a user to access system 130 using their computer system 110 following successful completion of the auction process to initiate a method of obtaining unsolicited bid proposal audio files using telephony system 140, described below in detail with reference to FIGS. 3 and 4.

Telephony system 140 is a system configured to allow system 130 to initiate and record a telephone conversation with a user through a device 160 to obtain the unsolicited bid proposal audio files using computer telephone integration CTI software and telephony hardware. CTI software enables computer system 130 to know about and control phone functions such as making and receiving voice, fax, and data calls with telephone directory services and caller identification. According to one exemplary embodiment, telephony system 140 and system 130 may be implemented using a single computing system.

The CTI software may be configured as an interface between system 130 and the telephone network 150. The software translates commands entered by a user into a website hosted by system 130 into commands that trigger telephony hardware. This functionality allows system 130 to call users (or allows the users to call system 130), and initiate system 130 to record the audio being provided through a device 160.

Telephony hardware may include any type of hardware configured to allow system 130 to connect to a plurality of devices 160 over a telephone network 150. The hardware may consist on Session Border Controller (SBC) clusters, routing clusters and media gateways, as are generally known in the art.

Telephone network 150 may be any telephone network such as the Public Switched Telephone Network (PSTN), the network of the world's public circuit-switched telephone networks. Telephone network 150 is configured to allow audio and data to be transmitted and received between system 130 and devices 160.

User telephone device 160 may include any type of device configured to allow a user to receive a telephone call from system 130. Exemplary devices may include, but are not limited to telephones, mobile phones, VOIP (or similar) devices, etc. Although a single connection and two devices 160 are shown, it should be understood that system 130 may be configured to allow connections to a large number of devices 160 through a large number of telephone connections.

In operation, system 100 is configured to allow users to initiate a bidding and submission process for submitting an unsolicited bid proposal using a telephony system as will be described in further detail below. The unsolicited bid proposal may be provided for review, rating, etc. in a bid proposal review process. The unsolicited bid proposal may further be appended to by reviewers using system 100 to include comments on the bid proposal, potential extensions of the submitted ideas, etc.

Referring now to FIG. 2, a flowchart 200 illustrating a method for implementing an auction for the right to submit an unsolicited bid proposal implemented by proposal auctioning system 125 is shown, according to an exemplary embodiment. The method may be implemented on a corporate contact page, on a venture capitalist website, etc. If an individual wishes to pitch a product, idea, venture, etc. to a person within the organization, they are provided with the method allowing them to bid for the opportunity. The organization may set a minimum bid price for unsolicited pitches. The size of the minimum bid price may be set based on the person being accessed, the number of bids being received, etc. An organization may offer bids for however many number of bids that the organization wishes to review.

In a step 202, an unsolicited bid proposal auction home page may be display to a bidder. The home page may be configured to display a welcome message such as “Acme Co.'s CIO accepts five unsolicited pitches daily. Yesterday, the average winning bid was $150.00. If you wish to participate, please enter your bid amount here and your email address. In step 202, the proposal auctioning system 125 is configured to receive the entered bid and the bidders contact information.

In a step 204, proposal auctioning system 125 is configured to compare the received bid to all other bids as they are received and calculate the winning bid received within the relevant time period. Winning bids may be calculated based purely on the amount provided, but may also be calculated based on other factors such as frequency of bidding, identity of the bidder, successful prior completion of the auction process, prior profitability of bids by the bidder, subject matter of the proposal, etc.

According to an exemplary embodiment, the bidder may be notified immediately if their bid is insufficient to become a winning bid. A bidder may also be notified if a newly submitted bid by a third party changes the status of their previously submitted bid. Proposal auctioning system 125 may further retain non-winning bids in the queue for future auction such that these bids continue to compete until they are withdrawn or become winning bids such that a bid may win anytime it is sufficient depending on volume and the current market conditions.

In a step 206, following completion of an auctioning timeframe, a number of winning bids may be selected and the users notified via their submitted contact information. The notification may be an email including a link allowing the user to submit payment information and telephone number information where they wish to be called to conduct a telephonic submission of their bid proposal. The user is asks to submit payment prior to initiation of the telephonic submission process. If the payment is not received, the highest non-winning bidder is notified and allowed to submit their proposal. Proposal submission may be implemented using the method described below with reference to FIG. 3.

Referring now to FIG. 3, a flowchart 300 illustrating a method for allowing a user to submit unsolicited bid proposal audio files using their computing system 110 and phone device 160 is shown, according to an exemplary embodiment. According to an exemplary embodiment, system 130 may be configured to implement a registration function, where users that have successfully completed the auctioning process are able to access additional features, be recognized by system 130, etc. Flowchart 300 illustrates a method where the user has successfully completed an auction through system 125. Accordingly, system 130 can associate a telephony session with the user information provided and automatically associate recorded audio with the user's contact information.

The method described in flowchart 300 may be generally implemented by the user through a website hosted by system 130 and displayed on the user's computing system 110 over the communication network 120. The website may include a plurality of differing web pages based on the functionality being accessed by the user. Exemplary functionality may include submitting bid proposals, reviewing the bid proposal, providing comments, account initiation and management, etc.

In a step 302, the user selects a submit proposal link on the web page being displayed on their computing system 110. Upon receiving the submit proposal selection, system 130 may be configured to determine whether the user has previously established an account with system 130 and is logged on to their account in a step 304. If the user does not have an account or is not logged on, system 130 may be configured to initiate a log in procedure or account creation procedure as needed in a step 306.

In a step 308, a submit proposal web page may be displayed to the user including an “Initiate Call” link. Upon selection of the link, the user can be provided with a listing a previously entered telephone numbers associated with the user account in a step 310. The user may also be provided with an option to enter a new phone number. The user is provided with instructions that the phone number provided is the number of a phone at the user's current location on which they are prepared to receive a phone call from system 130.

In a step 312, the user initiates the phone call from their computing device 110 by selecting a “make call” link. Selecting the link prompts system 130 to connect to the selected telephone number through telephony system 140. The user telephone device receives the call from system 130 to create an audio connection to system 130. System 130 may be configured to display one or more status messages based on the status on the audio connection. Exemplary messages may include “calling,” “answered,” “recording,” “call completed,” etc.

Once the user is connected to system 130 through telephony system 140, system 140 may be configured to guide the user through a phone tree in a step 314 which provides the user with a variety of recorded messages and options that will facilitate generation and posting of the bid proposal.

In a step 316, upon answering of the call by the user, system 130 may be configured to confirm the telephone number, particularly where system 130 has not previously accessed the phone number. System 130 may be configured to play a recorded message asking the user to press a specified key to confirm that system 130 may use the telephone number.

Upon confirmation, system 130 may be configured to play a recorded welcoming message. The welcoming message may be configured to include a system identification, a bid proposal review description in a step 318, instructions in a step 320, promotional information, account information, etc.

Following the provided instructions, the user may record their unsolicited bid proposal audio files in a step 322 by speaking normally into their telephone device 160. The unsolicited bid proposal audio files may include a wide variety of subject matter as managed by system 130. The unsolicited bid proposal may be required to have a particular format and/or include particular information, potentially described in step 318 and/or managed by a series of recorded questions following by a recorded response from the bidder.

Once the user is finished recording, system 130 may be configured to provide the user with a plurality of options for handling the unsolicited bid proposal audio files in a step 324. Option may include reviewing, re-recording, submitting, etc. Upon completion of the user audio content generation, the user may end the phone call in a step 326.

System 130 may be configured to process the unsolicited bid proposal audio files in a step 328. Processing the audio content may include converting the recorded audio content to a website presentation format, cleaning the audio content to remove white noise, background noise, etc., posting the unsolicited bid proposal audio files on a confidential, internal bid proposal review website, etc. System 130 may further add the processed unsolicited bid proposal audio files to a database associated with system 130 in a step 330.

Following posting of the generated audio content, system 130 may be configured to prompt the user for additional information regarding the recorded audio through a web page displayed on their computing system 110 in a step 332. The additional information may include a title for the generated bid proposal and one or more tags. A tag may be an individual word that describes the subject matter of the bid proposal to make is easier for bid reviewers to review the bid proposal according to their expertise. For example, where the bid proposal is for a new electronics product, exemplary tags may include (“electronics,” “computers,” etc.) The tag and other additional information may alternatively be provided during the phone call and converted to text by a human representative, speech to text recognition software, etc.

The bid proposal may be posted in a step 334 such that the proposal may be accessed using system 130. The proposal may then be reviewed, voted on, commented on, shared, embedded, etc.

Although a particular series of steps are shown and described in a particular order in the flowcharts shown in FIGS. 2 and 3 and described above, it should be understood that the methods described with reference to these flowchart may be implemented using more, fewer, and/or a different ordering of the steps to perform the functions described therein.

Referring now to FIG. 4, a graphical interface 400 configured to implement bid proposal review is shown, according to an exemplary embodiment. Graphical interface 400 may be implemented using a web page created using hypertext markup language (HTML) or other language codes to implement the functions described hereinbelow.

Graphical interface 400 may be configured to display a plurality of unsolicited bid proposal audio files, the display including a link to the audio file that will launch an audio player and play back the audio file. The display may further include the title supplied by the bidder, comments from other reviewers, etc. Each submitted bid proposal file may be associated with a plurality of links including a play audio link 410, a rate proposal link 420, a view current data link 430, a post comment link 440, and a share link 450. Each of the described functions and methods may be associated with one or more user selectable icons, hyperlinks, text entry fields, images, text displays, embedded applications, etc.

Play audio link 410 may be configured to allow users to listen to the audio file using a player presented by system 130. The audio file may alternatively be played through embedded players designed to reside on personal websites, blogs, office networking sites, etc. Audio files may also be played through desktop widgets, mobile devices, cell phones, etc.

Rate proposal link 420 may be configured to allow content viewers to rate the feasibility, profitability, etc. of the bid proposal. The rating system 130 may include any of a variety of rating systems and methods. For example, system 130 may be configured to implement an incremental rating system such that each vote increases the ranking of the selected bid proposal relative to other proposals associated with system 130. Accordingly, the bid reviewers using system 130 will be able to collectively identify quality bid proposals for other reviewers.

View current data link 430 may be configured to allow a reviewer to display any data associated with the selected bid proposal, including both bidder generated information and information generated by system 130 and/or other reviewers. The displayed data may include, but is not limited to, when the proposal was submitted, the average rating provided by reviewers, etc. The displayed data may further include statistics regarding the submitter of the bid proposal. The statistics may be based on other submitted bids in addition to the current submitted bid. The statistics may include a bidder rating taking into account all of the bidders activities on system 130 both positive and negative. For example, a bidder rating may increase for repeatedly submitting proposals that are favorably received by reviewers. Other statistics may include a listing of the number of proposals submitted, financial data associated with prior submissions, etc.

Post comment link 440 allows a reviewer to provide feedback on the selected audio content. The feedback may include text comments, a scale rating, selection of a positive or negative rating, etc.

According to an exemplary embodiment, the posted comment link 44 may also allow a reviewer to provide their comments as a second audio content file to be associated with the selected proposal file. Advantageously, allowing follow on audio content files may allow reviewer to offer extension to an idea related to a particular submitted proposal.

Share link 450 allows a reviewer to select from a plurality of methods for sharing the selected bid proposal. Sharing methods may allow reviewers to easily submit links to individual bid proposals to multiple reviewers if the proposal is worth soliciting additional comments. Sharing may also include emailing links to individual bid proposal files, either to an individual identified by a specific email address or to an entire address book associated with the reviewer.

Although the system and method described herein was describe, in at least some exemplary embodiments, with reference to a unsolicited bid proposal review website, one of ordinary skill in the art could understand that the described system and method may be utilized for a number of applications.

Various alternatives are contemplated as being within the scope of the following claims particularly pointing out and distinctly claiming the subject matter regarded as the invention. It is also to be understood that, although the foregoing description and drawings describe and illustrate in detail one or more preferred embodiments of the present invention, to those skilled in the art to which the present invention relates, the present disclosure will suggest many modifications and constructions, as well as widely differing embodiments and applications without thereby departing from the spirit and scope of the invention.

It is claimed:

1. A computer-implemented method for auctioning rights and receiving recorded bid proposals using a telephony system, comprising:
(a) receiving one or more submitted bids for access to a bid proposal recording system;
(b) determining a winning bid from the one or more submitted bids;
(b) initiating a telephone call to a selected telephone number associated with the winning bid;
(c) recording at least a portion of the telephone call to generate a recorded bid proposal; and
(d) posting the recorded bid proposal on a computer implemented graphical interface to allow one or more proposal reviewer to access the recorded bid proposal.

2. The method of claim 1, further including providing a comment function on the graphical user interface to allow the one or more reviewers to provide a comment associated with the recorded bid proposal.

3. The method of claim 2, wherein the comment function is configured to implement an incremental rating system ranking the recorded bid proposal relative to other bid proposals displayed on the computer-implemented graphical user interface.

4. The method of claim 2, wherein the comment function is configured to allow users to initiate at least a second telephone call to provide additional generated audio content to be associated with the recorded bid proposal.

5. The method of claim 1, further including displaying a winning bid amount from a prior auction prior to receiving the one or more submitted bids.

6. The method of claim 5, further including setting a minimum bid amount and rejecting submitted bid lower that the minimum bid amount.

7. The method of claim 1, further including receiving one or more subject matter tags to be associated with the recorded bid proposal through the graphical user interface.

8. A computer-implemented system for generating audio content using a telephony system, comprising:
a bidding proposal right auctioning system configured to select a winning bid from one or more submitted bids for right to submit a bid proposal;
a telephony system configured to initiate a telephone call based on the selected winning bid; and
an unsolicited bid proposal audio files management system configured to perform a plurality of steps to receive audio bid proposals using the telephony system, including
(a) receiving a telephone call initiation request through a computer implemented graphical interface,
(b) initiating a telephone call to a selected telephone number,
(c) recording at least a portion of the telephone call to generate audio bid proposals, and
(d) posting the bid proposal on the computer implemented graphical interface to allow one or more reviewers to access the bid proposals.

9. The system of claim 8, wherein the management system is further configured to provide a comment function on the graphical user interface to allow the one or more reviewers to provide a comment to be associated with a selected bid proposal.

10. The system of claim 9, wherein the comment function is configured to implement an incremental rating system ranking the bid proposal relative to other bid proposals displayed on the computer-implemented graphical user interface.

11. The system of claim 9, wherein the comment function is configured to allow users to initiate at least a second telephone call to provide additional generated audio content to be associated with the bid proposal.

12. The system of claim 8, wherein the bidding proposal right auctioning system is configured to display a previously winning bid amount.

13. The system of claim 12, wherein the bidding proposal right auctioning system is further configured to set a minimum bid amount and to reject submitted bids lower than the minimum bid amount.

14. The system of claim 8, wherein the management system is further configured to receive one or more subject matter tags to be associated with the record bid proposal through the graphical user interface.

15. A computer-implemented method for generating audio content using a telephony system, comprising:
(a) receiving a telephone call;
(b) recording at least a portion of the telephone call to generate a recorded bid proposal;
(c) receiving a bid for the right to have the recorded bid proposal considered; and
(d) posting the generated audio content on a computer implemented graphical interface to allow one or more reviewers to access the generated audio content based on a determination that the received bid is a winning bid.

16. The method of claim 15, further including providing a comment function on the graphical user interface to allow the one or more reviewers to provide a comment associated with the recorded bid proposal.

17. The method of claim 16, wherein the comment function is configured to implement an incremental rating system ranking the recorded bid proposal relative to other recorded bid proposal displayed on the computer-implemented graphical user interface.

18. The method of claim 16, wherein the comment function is configured to allow users to initiate at least a second telephone call to provide additional generated audio content to be associated with the recorded bid proposal.

19. The method of claim 15, further including displaying a previously winning bid amount prior to receiving a bid for the right to have the recorded bid proposal considered.

20. The system of claim 15, further including receiving one or more subject matter tags to be associated with the record bid proposal through the graphical user interface.
